(19) United States
(12) Patent Application Publication
(10) Pub. No.: US 2003/0023643 A1
(43) Pub. Date: Jan. 30, 2003

(54) Method and apparatus for providing context-sensitive code ahead input

(75) Inventor: Paul Steven Halverson, Rochester, MN (US)

Correspondence Address: Gero G. McClellan, Thomason, Moser & Patterson, L.L.P., Suite 1500, 3040 Post Oak Boulevard, Houston, TX, 77056-6582, US

(73) Assignee: International Business Machines Corporation, Armonk, NY

(21) Appl. No.: 09/916,787

(22) Filed: Jul. 27, 2001

(51) Int. Cl. G06F 15/00

(52) U.S. Cl. 707/531

(57) ABSTRACT

A method, article of manufacture, and apparatus for providing context sensitive code ahead input to a user of a computer system. Initially, an entry for a document is received. A context in the document is identified based on a predefined definition of the received entry. The predefined definition associates the entry with a code ahead input. The code ahead input based upon the identified context is then displayed on a display device of the computer system.

### BACKGROUND OF THE DISCLOSURE

1. Field of the Invention

The invention relates to computers and computer software. More particularly, the invention relates to a method, article of manufacture and apparatus for providing context-sensitive code ahead input.

2. Description of the Background Art

Computer application programs often provide features for enhancing the entry of information. For example, programs such as Visual Age for Java and Microsoft Internet Explorer provide a “code ahead” or “text ahead” feature. To implement the code ahead feature, the application program analyzes the code, e.g., text, being entered and uses previous entries to anticipate future entries of code by the user. The anticipated entry is provided as a code ahead input in the form of a list of one or more possible codes or other forms of text.

The code ahead feature provides a user or programmer with a convenient shorthand means for entering commonly typed words or phrases, e.g., web pages, electronic addresses, and the like. The user may simply apply the code ahead feature instead of repeatedly typing the same words or phrases in a document, file or program. This also enables a quicker completion of the document or file.

However, current implementations of the code ahead feature may provide any word or phrase that is similar to a current word or phrase being entered. With longer documents having many similar words or phrases, the user may mistakenly select an incorrect code ahead from a list provided. In particular, such a mistake may cause problems in a program development environment. For example, a programmer may use the code ahead feature to enter the wrong type of variable in a procedure call. The incorrect procedure call would cause a compilation error that would then need to be debugged or otherwise fixed. Therefore, a need exists for a method and apparatus for providing a code ahead input that limits the possibility of error associated with current implementations of the code ahead feature.

### SUMMARY OF THE INVENTION

A method, article of manufacture and apparatus for providing a context based code ahead input to a user of a computer system are provided. Initially, an entry for a document is received. A context in the document is identified based on a predefined definition of the received entry. The predefined definition associates the entry with a code ahead input. The code ahead input may then be displayed based upon the identified context on a display device of the computer system.

### BRIEF DESCRIPTION OF THE DRAWINGS

The teachings of the present invention can be readily understood by considering the following detailed description in conjunction with the accompanying drawings, in which:

FIG. 1 depicts a block diagram of a computer system utilized in the present invention;

FIG. 2A depicts a first embodiment of providing context sensitive code ahead input;

FIG. 2B depicts a second embodiment of providing context sensitive code ahead input;

FIG. 2C depicts a third embodiment of providing context sensitive code ahead input;

FIG. 2D depicts a fourth embodiment of providing context sensitive code ahead input;

FIG. 3 depicts a flow diagram for processing user input;

FIG. 4 depicts a flow diagram of a method of a first embodiment of providing context sensitive code ahead input;

FIG. 5 depicts a flow diagram of a method of a second embodiment of providing context sensitive code ahead input;

FIG. 6 depicts a flow diagram of a method of a third embodiment of providing context sensitive code ahead input; and

FIG. 7 depicts a flow diagram of a method of a fourth embodiment of providing context sensitive code ahead input.

To facilitate understanding, identical reference numerals have been used, where possible, to designate identical elements that are common to the figures.

### DETAILED DESCRIPTION

The present invention is directed to providing a context based code ahead input. Initially, an entry for a document is received. A context of the document is identified. A determination is made as to whether the received entry is within the identified context. If the entry is within the identified context, a code ahead input is provided based upon the identified context. In this manner, it is not necessary that a combination of the entry and the code ahead input be previously entered and stored in memory for future retrieval and matching, as in prior art implementations of a code ahead input feature.

Various programs and devices described hereinafter may be identified based upon the application for which they are implemented in a specific embodiment of the invention. However, it should be appreciated that any particular program or device nomenclature that follows is used merely for convenience, and the invention is not limited to use solely in any specific application identified and/or implied by such nomenclature.

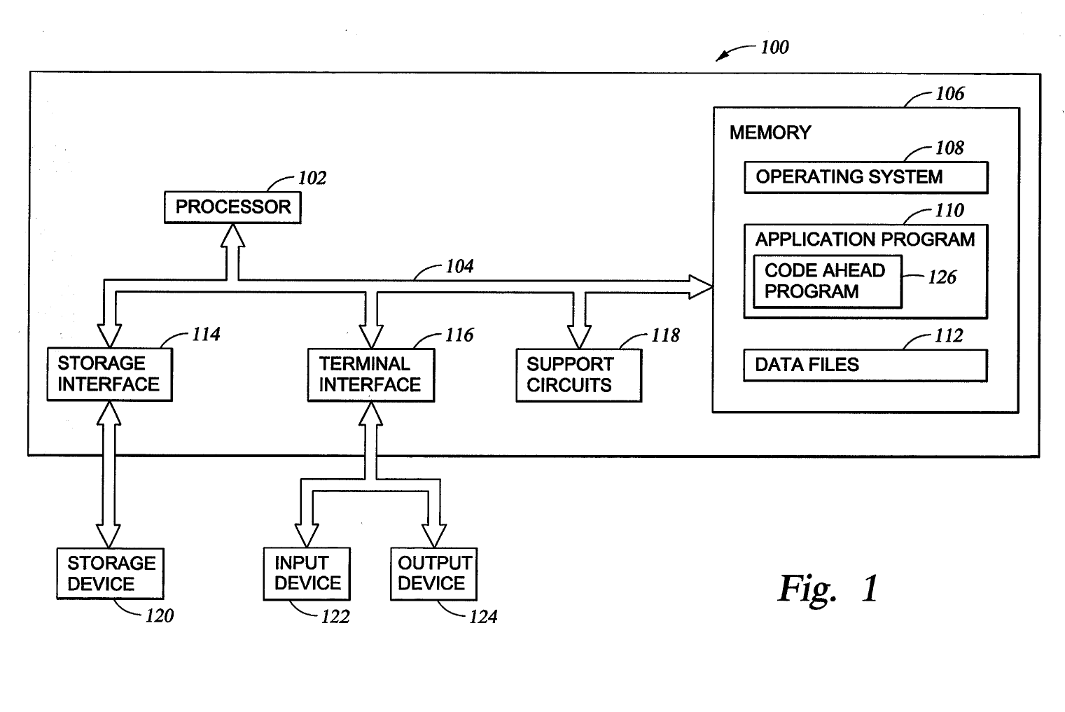

FIG. 1 depicts a computer system 100 illustratively utilized in accordance with the invention. The computer system 100 may represent any type of computer, computer system or other programmable electronic device, including a client computer, a server computer, a portable computer, an embedded controller, and the like. Illustratively, the computer system 100 comprises a standalone device. However, the computer system 100 may also comprise a device coupled to a computer network system. In one embodiment, the computer system 100 is an AS/400 available from International Business Machines of Armonk, N.Y.

The computer system 100 is shown in a multi-user programming environment having at least one processor 102, which obtains instructions and data from a main memory 106 via a bus 104. Examples of the computer system 100 include a PC-based server, a minicomputer, a midrange computer, a mainframe computer, and other computers adapted to support the methods, apparatus and article of manufacture of the invention.

In one embodiment, the main memory 106 includes an operating system 108, at least one application program 110, and a code ahead program 126. In addition, the main memory 106 may contain various data structures 112 (or data structures) used with the operating system 108, the application program 110, and the code ahead program 126. The main memory 106 may comprise one or a combination of memory devices, including Random Access Memory, nonvolatile or backup memory, (e.g., programmable or Flash memories, read-only memories, and the like). In addition, memory 106 may include memory physically located elsewhere in a computer system 100, for example, any storage capacity used as virtual memory or stored on a mass storage device or on another computer coupled to the computer system 100 via bus 104.

The computer system 100 is generally coupled to a number of peripheral devices. Illustratively, the computer system 100 is coupled to a storage device 120, input devices 122 and output devices 124. Each of the peripheral systems is operably coupled to the computer system via respective interfaces. For example, the computer system 100 is coupled to the storage device 120 via a storage interface 114, and is coupled to the input device 122 and the output device 124 via a terminal interface 116.

The support circuits 118 include devices that support the operation of the computer system 100. Examples of support circuits 118 include a power supply, a clock, and the like. The storage device 120 may comprise either a permanent or removable direct access storage device (DASD). The input devices 122 may comprise any device utilized to provide input to the computer system 100. Examples of input devices 122 include a keyboard, a keypad, a light pen, a touch screen, a button, a mouse, a track ball, a speech recognition unit, and the like. The output devices 124 may comprise any conventional display screen. Although shown separately from the input devices 122, the output devices 124 and input devices 122 could be combined. For example, a display screen with an integrated touch screen, and a display with an integrated keyboard, or a speech recognition unit combined with a text speech converter could be used.

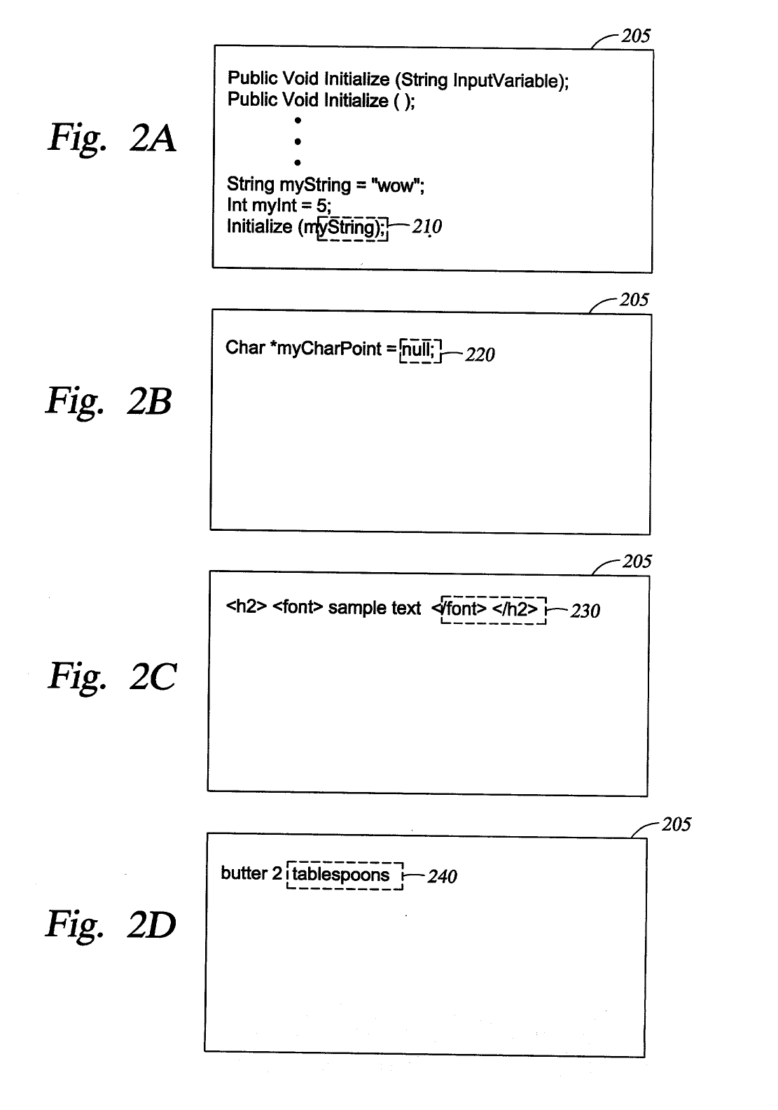

The operating system 108 is the software used for managing the operation of the computer system 100. Examples of the operating system 108 include IBM OS/400, UNIX, Microsoft Windows, and the like. The application program 110 represents any software program that the processor 102 may execute. A few of the many types of application programs 110 include web browsers, compiler programs, word processing programs, program development applications/editors and the like. In one embodiment, the application program 110 contains a code ahead program 126. The code ahead program 126 is implemented as a feature or tool for providing context sensitive code ahead input to a user of the application program 110. Different embodiments of the context sensitive code ahead feature are further described with respect to FIGS. 2A-2D. The data files 112 may comprise any file used during the execution of the application program 110 and/or the code ahead program 126. In one embodiment, these data files 112 include computer program files, word processing files, HTML (Hypertext Markup Language) files, and other documents.

In general, the routines executed to implement the embodiments of the invention, whether implemented as part of an operating system or a specific application, component, program, object, module or sequence of instructions will be referred to herein as the code ahead program 126, or simply as the program 126. The program 126 typically comprises one or more instructions that are resident at various times in various memory and storage devices in the computer system 100. When read and executed by one or more processors 102 in the computer system 100, the program 126 causes that computer system 100 to perform the steps necessary to execute steps or elements embodying the various aspects of the invention.

Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include, but are not limited to, recordable type media such as volatile and nonvolatile memory devices, floppy and other removable disks, hard disk drives, optical disks (e.g., CD-ROM, DVD, and the like), among others, and transmission type media such as digital and analog communication links.

FIG. 2A depicts a first embodiment of providing context sensitive code ahead input. In one embodiment, the context sensitive code ahead input is provided on a graphical user interface 205 of the output device 124, e.g., a display device. Suppose a user has already defined a procedure initialize with and without an argument. The argument in the procedure initialize is a string variable. In another location in the document, e.g., a computer program, the user then initializes a string variable myString and an integer variable myInt. The user enters a procedure call or invocation for the procedure initialize.

Suppose the user enters the first letter “m” of the parameter in the procedure call or invocation for the procedure initialize. Current available implementations of the code ahead input would simply list any word starting with the letter “m”, e.g., myString and myInt. Although only two words are provided in this simple example, such a list of words may become prohibitively long if the document contains thousands of lines of code.

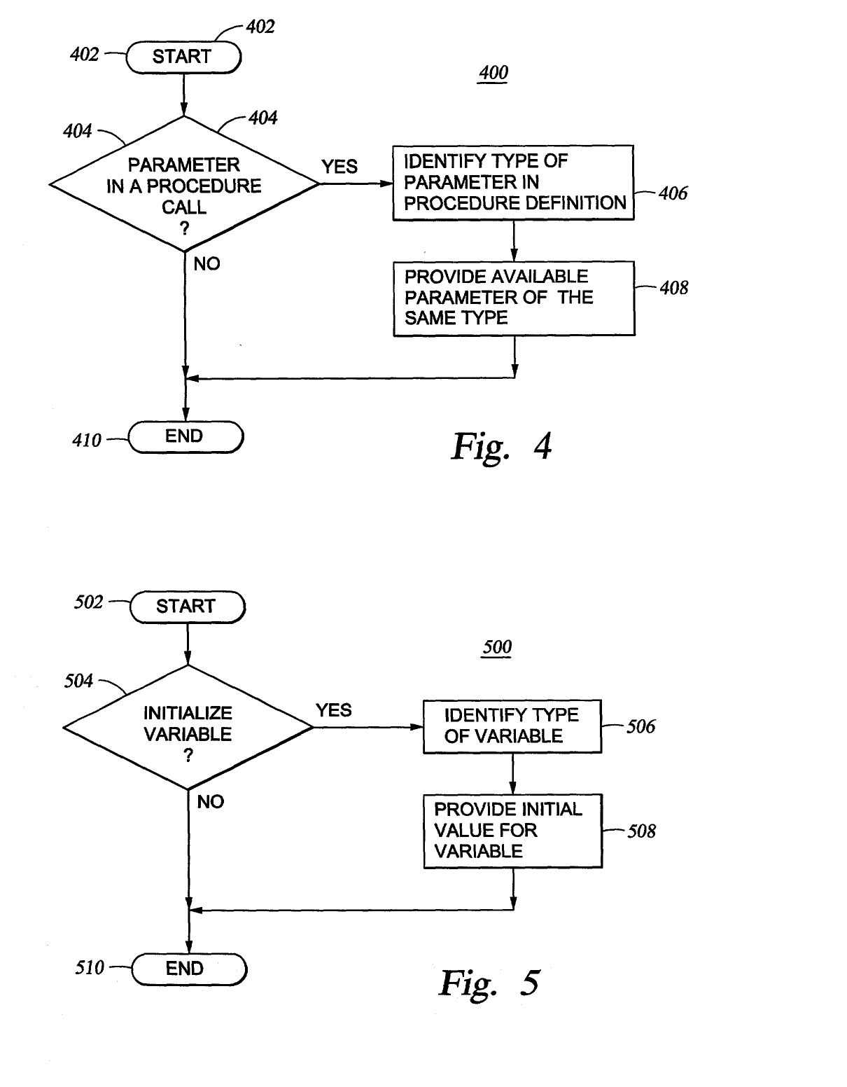

In contrast to the prior art, e.g., previous implementations of the code ahead input feature, the program 126 would use the context of the entry to provide the code ahead input. In this example, the program 126 would recognize that the parameter was previously defined as a string variable within the procedure definition for the procedure initialize. The program 126 would then limit the context based code ahead input 210 to a previously entered string variable, e.g., myString. As such, the program 126 limits the code ahead input to previously entered words that are of the type contained within the procedure definition for the procedure initialize. A method for this embodiment is further described with respect to FIG. 4.

FIG. 2B depicts a second embodiment of providing context sensitive code ahead input. Suppose the user is about to initialize a pointer variable myCharPoint. In this example, the pointer variable myCharPoint points to a character value. When the user starts to initialize the pointer variable myCharPoint, e.g., by typing the equal sign “=”, the program 126 would provide a code ahead input based on the context of the entry. Specifically, the program 126 would recognize that the variable myCharPoint is a pointer variable to a character value and provide context sensitive code ahead input that is the same type of the variable specified in the variable definition.

In contrast to previous implementations of the code ahead feature, the program 126 may provides a code ahead input that is different previously entered input. For the variable myCharPoint, the code ahead input 220 provided would be in the form of a proposed character value, e.g., a null value. Such an initial value is subject to change by the user. A method for this embodiment is further described with respect to FIG. 5.

FIG. 2C depicts a third embodiment of providing context sensitive code ahead input. Suppose a user is programming a HTML file and is about to apply a function to a text entry, i.e., a block of text. Exemplary functions include indenting the text entry, setting the font of the text entry, bolding the text entry, setting the color of the text entry, and other functions known in the art. To program such closed-end text entries, a starting HTML element and an ending HTML element are required by convention. For example, the starting HTML elements may include <h2> and <font>, and the ending HTML elements may include </font> and </h2>.

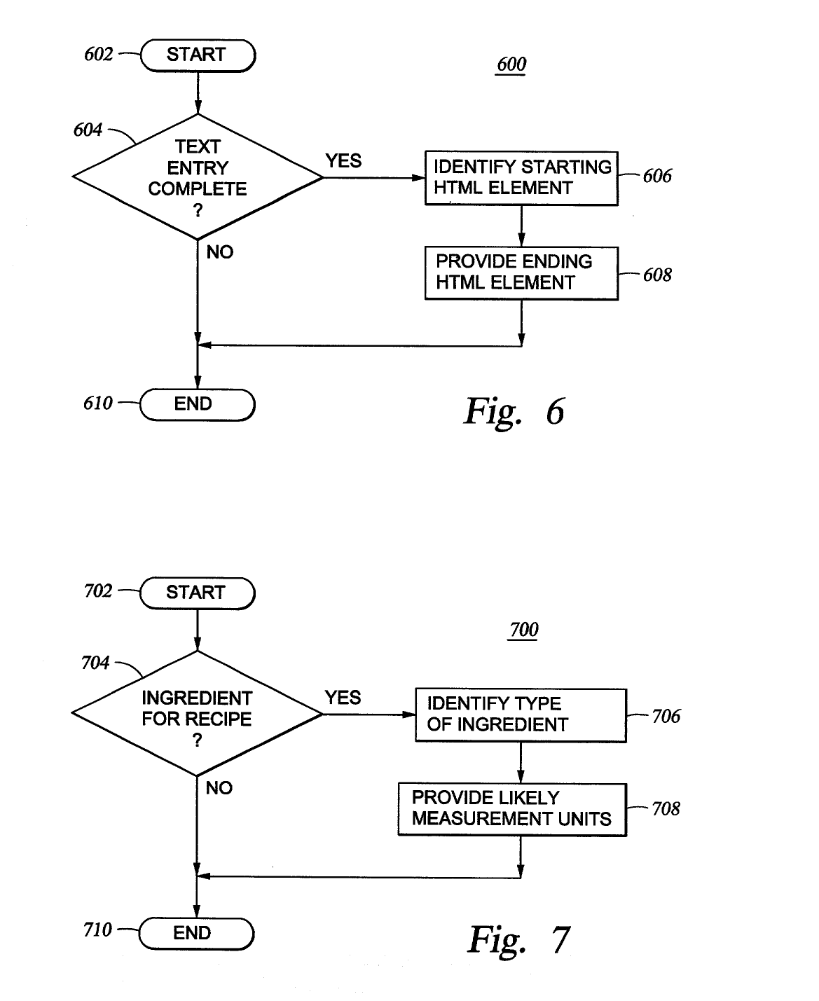

Assuming that the user has already entered the starting HTML element and the text entry, the program 126 would then provide context sensitive code ahead input 230 once the user starts the type the ending HTML element or otherwise indicates (e.g., by a shorthand command) the end of the text entry. It is important to note that the code ahead input is not limited to previously entered words as in previous implementations of the code ahead input feature. A method for this embodiment is further described with respect to FIG. 6.

FIG. 2D depicts a fourth embodiment of providing context sensitive code ahead input. Suppose a user desires to enter ingredients in a recipe. The user has entered the ingredient butter and starts to enter the quantity of butter required for the recipe. The program 126 would recognize that some types of units are associated with certain types of ingredients. For example, the program 126 would recognize that butter is usually provided in tablespoons and not in gallons. As such, the program 126 would apply this knowledge to provide a context sensitive code ahead input 240 in the form of one or more likely used units, e.g., tablespoons, for the entered ingredient butter. In one embodiment, the provided code ahead input is from a data file 112 of common recipe terms. This is different than previous implementations of the code ahead input feature which generally limited code ahead inputs to previously entered terms or words. A method for this embodiment is further described with respect to FIG. 7.

It should be understood that the above embodiments are merely illustrative of the available context sensitive code ahead inputs provided by the program 126. As such, other context sensitive code ahead inputs are contemplated within the scope of the invention. Additionally, different application programs 126 may apply combinations of one or more of the above embodiments. By applying the context of the user entry, the program 126 provides a code ahead input represents a more accurate prediction of what the user may enter.

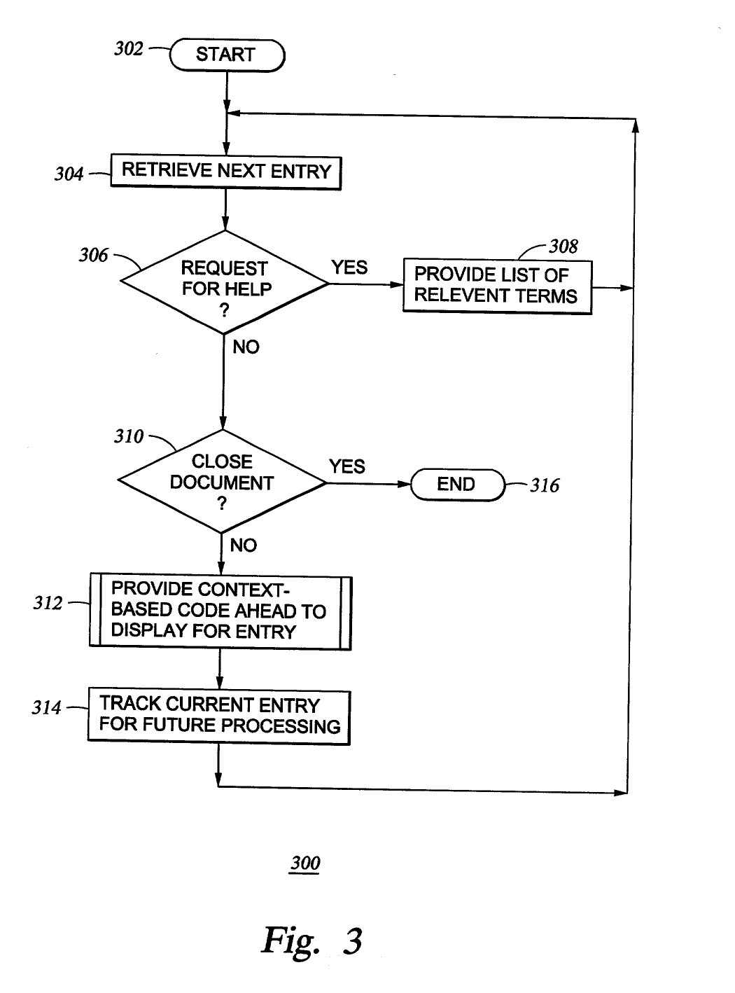

FIG. 3 depicts a flow diagram of a method 300 for processing user input. In one embodiment, the method 300 processes entries from a user via an input device 122, e.g., a keyboard. The method 300 starts at step 302 and proceeds to step 304 where an entry is retrieved. At step 306, a query determines whether the entry is a request for help. If the entry is a request for help, the method 300 proceeds to step 308 where a list of relevant terms is provided. The exact nature of the terms is dependent on the context of the entry. For example, if the entry is in a programming context, step 308 would provide a list of variables and procedures in a program file. After step 308, the method 300 returns to step 304 where the next entry is retrieved.

If the entry is not a request for help, the method 300 proceeds to step 310 where a query determines whether the entry is to close the document. In one embodiment, the document is a computer program in a program development environment. The entry may be a shorthand command in a particular application program 126. If the entry is to close the document, the method 300 proceeds to end at step 316. If the entry is not to close the document, the method 300 proceeds to step 312 where context based code ahead input is provided to display, i.e., on the output device 124, for the entry. Namely, step 312 provides a code ahead based upon the context of the entry. Exemplary embodiments of step 312 are further described with respect to FIGS. 4-7. However, one having ordinary skill in the art would readily notice that step 312 also includes other embodiments of context based code ahead input and, as such, is not limited to the embodiments depicted in FIGS. 4-7.

After providing the context based code ahead input in step 312, the method 300 proceeds to step 314 where the current entry is tracked for future processing. In one embodiment, step 314 may store the entry in the memory 106 as a data structure or data file 112. After step 314, the method 300 proceeds to step 304 where the next entry was retrieved.

FIG. 4 depicts a flow diagram of a method 400 for providing a first embodiment of the context sensitive code ahead input. The method 400 is embodied as step 312 described above with reference to FIG. 3. An exemplary application of the method 400 was described with reference to FIG. 2A. The method 400 starts at step 402 and proceeds to step 404 where a query determines whether an entry is identified as a parameter in a procedure call. In one embodiment, step 404 may identify whether the procedure has previously been defined in a document where the entry is being made. For example, step 404 may determine whether a parameter was previously entered in a procedure definition for the procedure initialize.

If the entry is not an entry of a parameter in a procedure call, the method 400 proceeds to end at step 410. If the entry is for an entry of a parameter in a procedure call, the method 400 proceeds to step 406 where the correct parameter type for the entry is determined. Step 406 identifies the type of parameter in the procedure definition. In the example of FIG. 2A, the parameter in the procedure initialize was defined as a string variable representing a string of characters.

At step 408, the method 400 provides the context based code ahead input for the entry. In one embodiment, the code ahead input includes a parameter of the same type determined at step 406. Additionally, if the procedure has multiple parameters, the context based code ahead input may include the remaining parameters for the procedure. For example, step 408 may provide a parameter, e.g., myString, that was previously entered and is of the same type in the procedure definition. However, in contrast to previous implementations of code ahead input features, step 408 does not provide a list of all previously entered words that are similar to a current entry. As such, step 408 would not provide the parameter myInt as code ahead input since myInt is not the type of parameter in the procedure initialize, i.e., myInt is an integer variable and the parameter in the procedure initialize is a string variable. After step 408, the method 400 proceeds to end at step 410.

FIG. 5 depicts a flow diagram of a method 500 for providing a second embodiment of the context sensitive code ahead input. The method 500 is embodied as step 312 described above with reference to FIG. 3. An exemplary application of the method 500 was described with reference to FIG. 2B. The method 500 starts at step 502 and proceeds to step 504 where a query determines whether an entry is an initialization of a variable. In one embodiment, step 504 determines whether the variable has been previously defined in a document, e.g., a computer program. For the example of FIG. 2B, step 504 searches for a definition of the pointer variable myCharPoint.

If the entry is not an initialization of a previously defined variable, the method 500 proceeds to end at step 510. If the entry is an initialization of a previously defined variable, the method 500 proceeds to step 506 where the type of variable is identified. At step 508, an initial value for the variable is provided as a context based code ahead input. The value of the variable is of the same type identified at step 506. For the example in FIG. 2B, step 508 will assign a character value to the integer variable myCharPoint. In one embodiment, the provided code ahead input, e.g., 220 or a null value, is typically some default value and is subject to change by the user. After step 508, the method 500 proceeds to end at step 510.

FIG. 6 depicts a flow diagram of a method 600 for providing a third embodiment of the context sensitive code ahead input. The method 600 is embodied as step 312 described above with reference to FIG. 3. An exemplary application of the method 600 was described with reference to FIG. 2C. The method 600 starts at step 602 and proceeds to step 604 where a query determines whether an entry identifies the end of a closed-ended text entry. In one embodiment, a shorthand command, e.g., ctrl key depressed in combination with another key, may signal the end of the text entry. In another embodiment, the presence of a left bracket, i.e., <, immediately after the text entry may signal the beginning of an ending HTML element and the end of the HTML entry.

If the entry is not identified as the end of a closed-ended text entry, the method 600 proceeds to end at step 610. If the entry is identified as the end of a closed-ended text entry, the method 600 proceeds to step 606 where the corresponding starting HTML element is identified. At step 608, the context based code ahead input is provided in the form of the ending HTML element. The method 600 then proceeds to end at step 610.

FIG. 7 depicts a flow diagram of a method 700 for providing a fourth embodiment of the context sensitive code ahead input. The method 700 is embodied as step 312 described above with reference to FIG. 3. An exemplary application of the method 700 was described with reference to FIG. 2D. The method 700 starts at step 702 and proceeds to step 704 where a query determines whether an entry is an ingredient, e.g., butter, for a recipe. In one embodiment, step 702 may determine whether the entry is contained in a list or data structure of commonly used ingredients. The exact content in the list of ingredients is dependent on the item to be created using the recipe.

The method 700 proceeds to step 706 where the type of unit is identified or estimated for the ingredient. For example, butter is used in terms of “tablespoons” instead of “gallons.” At step 708, a context based code ahead input is provided for the entry. For the example of FIG. 2D, the code ahead input 240 is the word “tablespoons.” The code ahead input may represent a default value that is subject to change by the user. After step 708, the method 700 ends at step 710.

Although the foregoing methods have been described separately, it is understood that each method may be invoked from a single program, e.g., code ahead program 126. In addition, persons skilled in the art will recognize other embodiments using context sensitive input.

Although various embodiments which incorporate the teachings of the present invention have been shown and described in detail herein, those skilled in the art can readily devise many other varied embodiments that still incorporate these teachings.

What is claimed is:

1. A method of providing context sensitive code ahead input to a user of a computer system, the method comprising:
receiving an entry for a document;
identifying a context in the document based on a predefined definition of the received entry, wherein the predefined definition associates the entry with a code ahead input; and
displaying, on a display device of the computer system, the code ahead input based upon the identified context.

2. The method of claim 1 wherein a combination of the entry and the code ahead input is not a previously entered entry retrieved from memory.

3. The method of claim 1 wherein identifying the context comprises identifying that the entry has been previously entered and then identifying the code ahead input based on the predefined definition of the entry.

4. The method of claim 1 wherein the context is a procedure call and the code ahead input is a parameter.

5. The method of claim 4 wherein the identifying comprises:
determining whether a procedure definition exists for the procedure call; and
identifying a type of the parameter in the procedure definition if the procedure definition exists for the procedure call, where type of code ahead input provided is the same as the type of parameter identified.

6. The method of claim 1 wherein the context is an initialization of a variable.

7. The method of claim 6 wherein the identifying comprises:
determining whether a variable definition exists for the variable; and
identifying a type of the variable in the variable definition if the variable definition exists for the variable, where the type of code input provided is the same as the type of variable identified.

8. The method of claim 1 wherein the entry is an end tag of a hyper text markup language (HTML) text entry and wherein identifying the context comprises identifying an associated start tag preceding the text entry.

9. The method of claim 1 wherein the entry is a listing of an ingredient in a recipe and wherein identifying the context comprises identifying an association to a unit of measurement.

10. The method of claim 1 wherein the identifying is performed iteratively for each character input at least until the code ahead input.

11. The method of claim 1 wherein the provided code ahead input is in a list of possible inputs based on the identified context.

12. The method of claim 1 further comprising:
providing, if the received entry is a request for help, a list of relevant terms to the user.

13. The method of claim 12 wherein the list of relevant terms comprises variables and procedures in the document.

14. The method of claim 12 wherein the list of relevant terms comprises ingredients for a recipe.

15. An apparatus for providing context sensitive code ahead input to a user, the apparatus comprising:
a memory for storing a code ahead program and a document;
a display device for displaying a code ahead input to the user; and
a processor, for executing the code ahead program, the processor being configured to:
receive an entry for the document,
identify a context in the document based on a predefined definition of the received entry, wherein the predefined definition associates the entry with a code ahead input, and
provide, to the display device, the code ahead input based upon the identified context

16. The apparatus of claim 15 wherein a combination of the entry and the code ahead input is not a previously entered entry retrieved from the memory.

17. The apparatus of claim 15 wherein the context is a parameter of a procedure call.

18. The apparatus of claim 15 wherein the context is an initialization of a variable.

19. The apparatus of claim 15 wherein the entry is an end tag of a HTML text entry and wherein the processor identifies the context by identifying an associated start tag preceding the text entry.

20. The apparatus of claim 15 wherein the context is a listing of an ingredient in a recipe.

21. A computer readable medium storing a software program that, when executed by a processor of a computer, causes the computer to perform operations comprising:
parsing an entry for a document;
identifying a context in the document based on a predefined definition of the received entry, wherein the predefined definition associates the entry with a code ahead input; and
outputting, to a display device, the code ahead input based upon the identified context.

22. The computer readable medium of claim 21 wherein a combination of the entry and the provided code ahead input not a previously entered entry retrieved from memory.

23. The computer readable medium of claim 21 wherein identifying the context comprises identifying that the entry has been previously entered and then identifying the code ahead input based on the predefined definition of the entry.

24. The computer readable medium of claim 21 wherein the context is a procedure call and the code ahead input is a parameter.

25. The computer readable medium of claim 24 wherein the identifying comprises:
determining whether a procedure definition exists for the procedure call; and
identifying a type of the parameter in the procedure definition if the procedure definition exists for the procedure call, where type of code ahead input provided is the same as the type of parameter identified.

26. The computer readable medium of claim 21 wherein the context is an initialization of a variable.

27. The computer readable medium of claim 26 wherein the identifying comprises:
determining whether a variable definition exists for the variable; and
identifying a type of the variable in the variable definition if the variable definition exists for the variable, where the type of code input provided is the same as the type of variable identified.

28. The computer readable medium of claim 21 wherein the entry is an end tag of a hyper text mark-up language (HTML) text entry and wherein identifying the context comprises identifying an associated start tag preceding the text entry.

29. The computer readable medium of claim 21 wherein the entry is a listing of an ingredient in a recipe and wherein identifying the context comprises identifying an association to a unit of measurement.

30. The computer readable medium of claim 21 wherein the identifying is performed iteratively for each character input at least until the code ahead input.

31. The computer readable medium of claim 21 wherein the provided code ahead input is in a list of possible inputs based on the identified context.
